(19) United States
(12) Patent Application Publication
(10) Pub. No.: US 2008/0275743 A1
(43) Pub. Date: Nov. 6, 2008

(54) SYSTEMS AND METHODS FOR PLANNING

(76) Inventor: Shubha L. Kadambe, Thousand Oaks, CA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 11/743,692

(22) Filed: May 3, 2007

(51) Int. Cl. G06Q 10/00; G06F 17/00

(52) U.S. Cl. 705/7

(57) ABSTRACT

A computer-implemented method of identifying a preferred plan includes modeling one or more plans, each plan having a respective plurality of states and a respective plurality of transitions between the states, generating a respective state transition probability matrix associated with each one of the one or more plans, and generating a respective observation probability matrix associated with each one of the one or more plans. A respective plurality of state histories is identified and a respective quality value for is computed for each state history. A respective expected value is computed for each plan. A preferred plan is identified in accordance with the expected values. A preferred state history is identified in accordance with the quality values. A computer-readable storage medium and a system having a computer-readable storage medium are also provided, each of which is encoded with instructions for performing the method.

### FIELD OF THE INVENTION

This invention relates generally to systems and methods used for generating a plan and, more particularly, to systems and methods that can automatically identify a preferred plan from among one or more plans and that can automatically identify a preferred path through the preferred plan.

### BACKGROUND OF THE INVENTION

Computer-implemented planning models have been applied to a variety of plans. Some of these computer-implemented planning models provide only a static plan, for which static inputs to the plan provide only static and deterministic outputs. For example, a static plan for moving equipment or materials among a variety of locations can provide a static view of the equipment or material available at each location versus time. For another example, a static construction plan can provide a schedule of activities.

Often a selection of a preferred plan from among more than one plan is performed manually, for example, by qualitative inspection. Other times the selection of a plan can be based upon simple quantitative parameters. For example, a plan that results in certain quantities of equipment or material disposed at the various locations can be manually compared to another plan that results in a different quantities of equipment or material disposed at the various locations. The above-described static plans and manual comparisons of plans do not necessarily result in a best plan or even a preferred plan.

### SUMMARY OF THE INVENTION

The present invention provides an ability to automatically select a preferred plan from among one or more plans and an ability to automatically select a path through the preferred plan.

In accordance with one aspect of the present invention, a computer-implemented method of identifying a preferred plan includes modeling one or more plans, each plan having a respective plurality of states and a respective plurality of transitions between the states. The method also includes generating a respective state transition probability matrix associated with each one of the one or more plans. Each respective state transition probability matrix has respective state transition probability matrix values. Each state transition probability matrix value corresponds to a respective probability that performing a respective action will result in a respective state transition. The method also includes generating a respective observation probability matrix associated with each one of the one or more plans. Each respective observation probability matrix has respective observation probability matrix values. Each observation probability matrix value corresponds to a respective probability of obtaining a respective observation in response to a respective action. The method also includes identifying a respective plurality of state histories associated with each one of the one or more plans, each state history having a respective plurality of states, computing a respective quality value for each state history of the plurality of state histories, and computing a respective expected value for each plan of the one or more plans. The method also includes identifying at least one of a preferred plan from among the one or more plans in accordance with the expected values of each plan of the one or more plans, or a preferred state history from among the respective plurality of state histories within the identified preferred plan. The preferred state history is identified in accordance with the quality values.

In accordance with another aspect of the present invention, a computer-readable storage medium encoded with computer-readable code includes instructions for modeling one or more plans, each plan having a respective plurality of states and a respective plurality of transitions between the states. The computer-readable code also includes instructions for generating a respective state transition probability matrix associated with each one of the one or more plans. Each respective state transition probability matrix has respective state transition probability matrix values. Each state transition probability matrix value corresponds to a respective probability that performing a respective action will result in a respective state transition. The computer-readable code also includes instructions for generating a respective observation probability matrix associated with each one of the one or more plans. Each respective observation probability matrix has respective observation probability matrix values. Each observation probability matrix value corresponds to a respective probability of obtaining a respective observation in response to a respective action. The computer-readable code also includes instructions for identifying a respective plurality of state histories associated with each one of the one or more plans, each state history having a respective plurality of states, computing a respective quality value for each state history of the plurality of state histories, and computing a respective expected value for each plan of the one or more plans. The computer-readable code also includes instructions for identifying at least one of a preferred plan from among the one or more plans in accordance with the expected values of each plan of the one or more plans, or a preferred state history from among the respective plurality of state histories within the identified preferred plan. The preferred state history is identified in accordance with the quality values.

In accordance with another aspect of the present invention, a system includes a computer processor, and a computer-readable memory coupled to the computer processor, wherein the computer-readable memory is encoded with computer-readable code. The computer-readable code includes instructions for modeling one or more plans, each plan having a respective plurality of states and a respective plurality of transitions between the states. The computer-readable code also includes instructions for generating a respective state transition probability matrix associated with each one of the one or more plans. Each respective state transition probability matrix has respective state transition probability matrix values. Each state transition probability matrix value corresponds to a respective probability that performing a respective action will result in a respective state transition. The computer-readable code also includes instructions for generating a respective observation probability matrix associated with each one of the one or more plans. Each respective observation probability matrix has respective observation probability matrix values. Each observation probability matrix value corresponds to a respective probability of obtaining a respective observation in response to a respective action. The computer-readable code also includes instructions for identifying a respective plurality of state histories associated with each one of the one or more plans, each state history having a respective plurality of states, computing a respective quality value for each state history of the plurality of state histories, and computing a respective expected value for each plan of the one or more plans. The computer-readable code also instructions for identifying at least one of a preferred plan from among the one or more plans in accordance with the expected values of each plan of the one or more plans, or identifying a preferred state history from among the respective plurality of state histories within the identified preferred plan. The preferred state history is identified in accordance with the quality values.

### BRIEF DESCRIPTION OF THE DRAWINGS

The foregoing features of the invention, as well as the invention itself may be more fully understood from the following detailed description of the drawings, in which:

FIG. 1 is a block diagram showing two generic states, each having state variables, a transition between the two states, the transition having an associated transition probability, and observations associated with the state transition, the observations having associated observation probabilities;

FIG. 2 is a block diagram showing two specific exemplary states, each having state variables, a transition between the two states, the transition having an associated transition probability, and observations associated with the state transition, the observations having associated observation probabilities;

FIG. 3 is a block diagram showing a plan having a plurality of states coupled by transitions, each transition having a respective transition probability;

FIG. 3A is a block diagram showing another plan having another plurality of states coupled by transitions, each transition having a respective transition probability;

FIG. 4 is a flow chart showing a method of identifying a preferred plan from among a plurality of plans and a preferred path (state history) through the preferred plan;

FIG. 5 is a flow chart showing a method of determining a quality value associated with a state history;

FIG. 6 is a flow chart showing a method of determining an expected value associated with a plan; and

FIG. 7 is a block diagram of a system that can be used to implement the methods of FIGS. 4-6.

### DETAILED DESCRIPTION OF THE INVENTION

Before describing the present invention, some introductory concepts and terminology are explained. As used herein, the term “plan” is used to describe a plurality of states and state transitions between the states. Each state is described herein by way of so-called “state variables.” As used herein, the term “state history” is used to describe a path among states within a plan, the path involving two or more states connected by respective state transitions.

As used herein, the term “preferred” is used to describe a plan selected from among a plurality of plans or a state history selected from among a plurality of state histories based upon certain comparison methods and comparison values described more fully below. It should be understood that the preferred path or preferred state history can be a different path or different state history depending upon the particular comparison methods and comparison parameters. Exemplary comparison parameters and methods are described below. It should be further understood that, based upon the comparison parameters, a preferred plan can be deemed to be an “optimal” plan, the best of the plans. However, a preferred plan need not be an optimal plan. A preferred plan is a selected plan as described above.

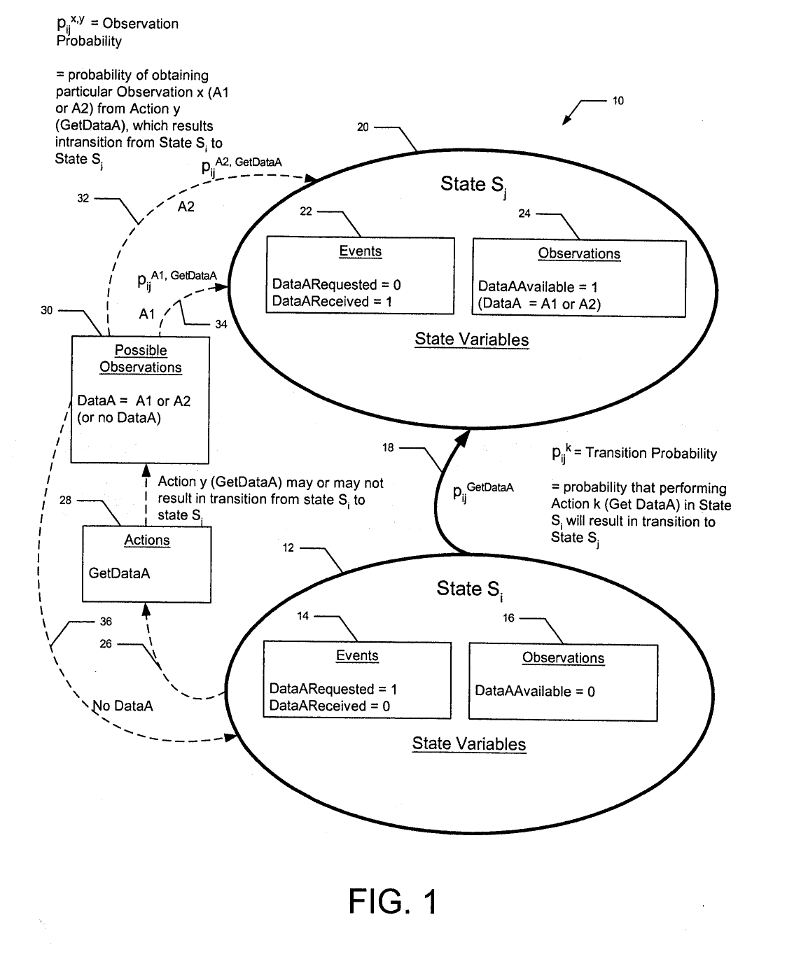

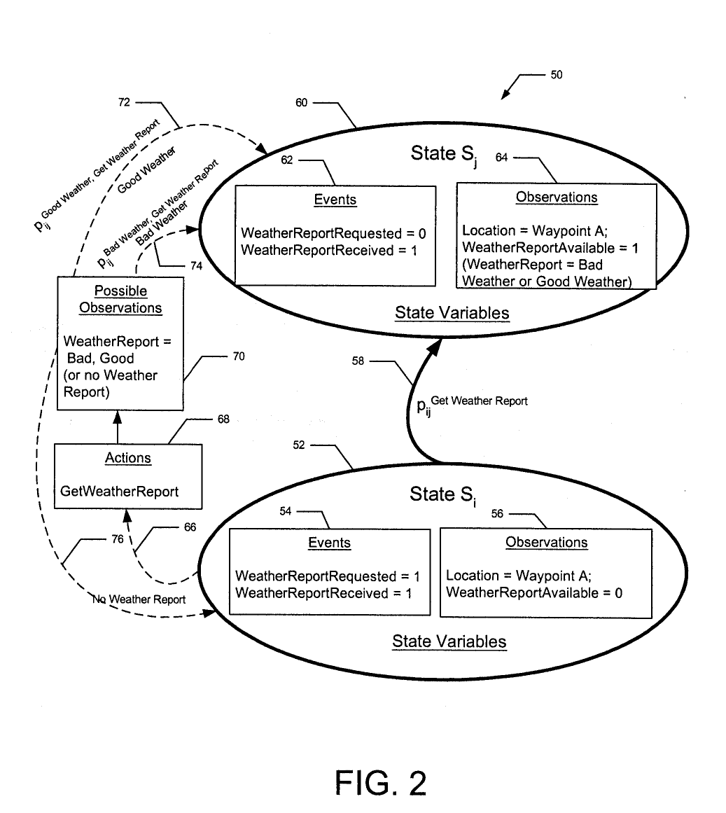

Referring to FIG. 1, an exemplary plan 10 includes an exemplary state Sᵢ 12. The state Sᵢ 12 includes state variables, including so-called “events” 14 and also so-called “observations” 16. An example of specific states, events, and observations is described below in conjunction with FIG. 2.

In some arrangements, the events 14 have event values that can be represented as two state binary numbers, each of which can be representative of a so-called “action” having occurred or an observation having been received. For example, a event DataARequested can be represented as a zero or a one, wherein a one can represent that an action GetDataA has occurred, i.e., a data of type DataA has been requested, and a zero can represent that the action GetDataA has not occurred, i.e., DataA has not been requested. Similarly, an event DataAReceived can be represented as a zero or a one, wherein a one can represent that an observation DataA has occurred, i.e., the data of type DataA has been received, and a zero can represent that the observation DataA has not occurred, i.e., DataA has not been received.

The observations 16 can have observation values, which can be two state binary numbers, multi-valued numbers, and/or text descriptions. For example, the above-described observation of data of type DataA can result in a binary number DataAAvailable, wherein a zero is representative of the data of type DataA not being available and a one is indicative of the data of type DataA being available. For this example, there appears to be only a small distinction between the event DataAReceived and the observation DataAAvailable. This distinction will become more apparent below from the discussion in conjunction with FIG. 2.

In the state Sᵢ 12, the event DataAReceived has not occurred, and therefore, the observation, DataAAvailable, of data of the type DataA is a zero. However, in the state Sᵢ 12, an event 14 has occurred to request the data of type DataA (i.e., DataARequested=1) and DataAAvailable=1, (with DataA=A1 or A2).

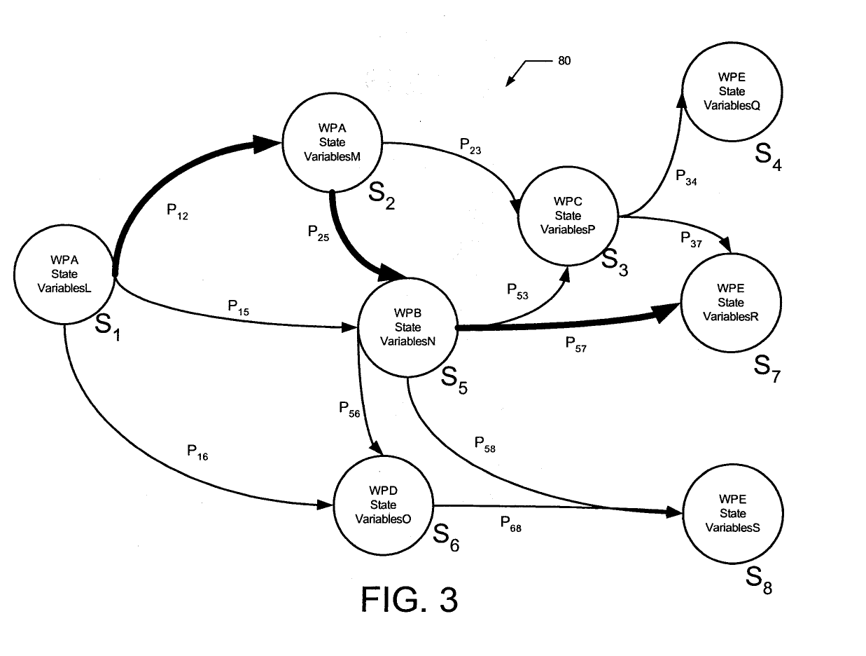

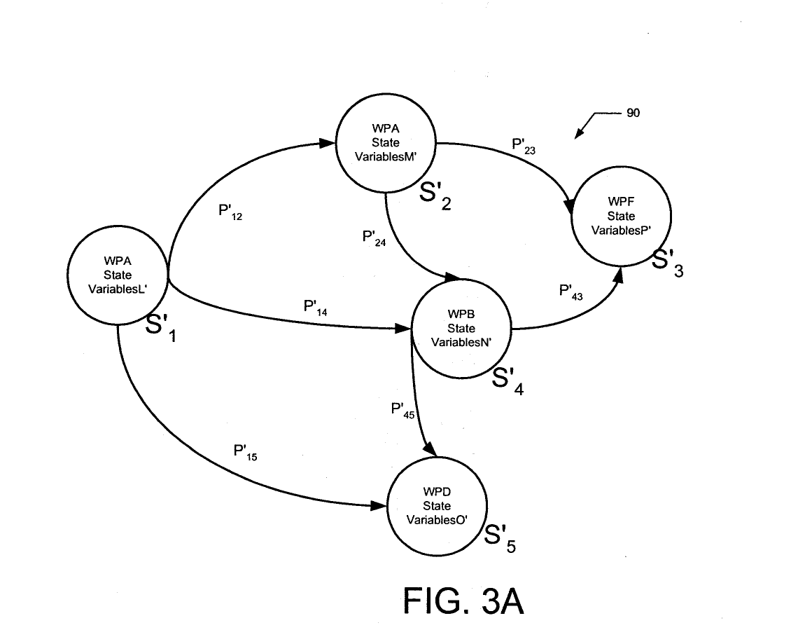

A transition 18 can occur to cause the plan 10 to move from the state Sᵢ 12 to a state Sⱼ 20. The transition 18 is associated with a transition probability Pᵢⱼ^{GetDataA}, which represents a probability that performing an action k (i.e., an action GetDataA 28) results in the transition to the particular state Sⱼ 20. It will become apparent from discussion below in conjunction with FIG. 3 that performing the action GetDataA 28 may not result in a transition 18 to the state Sⱼ 20. For example, if there is no data of type DataA, a return to the state Sᵢ 12 may occur on the exemplary path 36.

It is also possible that performing the action GetDataA 28 may result in a transition to a state different than the state Sⱼ 20. Given a different type of action than that shown, for example, an action to attempt to move a ship from a first waypoint to a second waypoint (which could be represented by first and second states), the movement action may not result in an arrival at the second waypoint (the second state), if for example, the ship is hit by a torpedo and sinks.

The events 14 can result in actions 28. In particular, the event DataARequested=1 can result in the action GetDataA 28. In turn, since the nature of the observation of data of type DataA is not known in advance, the action GetDataA 28 can result in an observation of the data of type DataA equal to values of either A1 or A2, either one of which results in the state Sⱼ 20.

The observation of the data of type DataA at block 30 is associated with observation probabilities pᵢⱼ^{A1,GetDataA} and Pᵢⱼ^{A2GetDataA}. The observation probability Pᵢⱼ^{A1,GetDataA} is the probability that the action GetDataA will result in the observation of data of type DataA equal to A1, represented by an arrow 34, which results in the transition 18 from the state Sᵢ 12 to the state Sⱼ 20, wherein the state Sⱼ 20 includes the observation 24 that the data of type DataA is equal to A1. Similarly, the observation probability Pᵢⱼ^{A2,GetDataA} is the probability that the action GetDataA will result in the observation of data of type DataA equal to A2, represented by an arrow 32, which results in the transition 18 from the state Sᵢ 12 to the state Sⱼ 20, wherein the state Sⱼ 20 instead includes the observation that the data of type DataA is equal to A2.

As described above, it is also possible that the action GetDataA 28 originating from the state Sᵢ 12 results in no data and the action GetDataA 28 returns to the original state Sᵢ 12 as represented by the arrow 36. As also described above, it is also possible that the action GetDataA 28 originating from the state Sᵢ 12 results in a different transition to a different state (not shown).

Referring now to FIG. 2, an exemplary plan 50 is comparable to the plan 10 of FIG. 1, but provides a more concrete real-world example. The plan 50 can be applied to a ship traveling on the ocean, between so-called “waypoints,” which are geographic locations to which the ship plans a course. The ship can request and receive weather reports. The ship can also move, though not represented in the particular states shown.

It will be recognized that the plan 50 is representative of a vehicle movement plan. A vehicle movement plan can include plan for moving a vehicle from a starting location to an ending location, which can also result in movement of at least one person within the vehicle from the starting location to the ending location. The vehicle can be, but is not limited to, a ship, an automobile, a truck, or an airplane.

The plan 50 includes an exemplary state Sᵢ 52. The state Sᵢ 52 includes state variables, including events 54 and also observations 56. In some arrangements, the events 54 include an event “WeatherReportRequested, “which can be represented as a zero or a one, wherein a one can represent that an action “GetWeatherReport” has occurred, i.e., data corresponding to (of a type) “WeatherReport” has been requested, and a zero can represent that the action GetWeatherReport has not occurred, i.e., the data corresponding to the WeatherReport has not been requested. Similarly, an event “WeatherReportReceived” can be represented as a zero or a one, wherein a one can represent that an observation of the data corresponding to the WeatherReport has occurred, i.e., the WeatherReport has been received, and a zero can represent that the observation of the data corresponding to the WeatherReport has not occurred, i.e., the WeatherReport has not been received.

The observations 16 can have observation values, which can be two state binary numbers, multi-valued numbers, and/or text descriptions. For example, the observation WeatherReportAvailable can be a zero, in which case the data of type WeatherReport in not available, or a one, in which case the case the data of type WeatherReport is available. It should be recognized that this variable has a slightly different interpretation than the event variable WeatherReportReceived. For example, the event WeatherReportReceived can be a one (i.e., true) but the observation WeatherReportAvailable can be a zero (i.e., false). This can occur, for example, when the data of type WeatherReport is received, but is not applicable to the location of the ship.

The above-described observation WeatherReportAvailable can also result in a familiar textual weather report (e.g. Bad Weather). In the state Sᵢ 52, the event WeatherReportReceived has not occurred, and therefore, the observation WeatherReportAvailable is a zero, which is indicative of no data of type WeatherReport. However, in the state Sᵢ 52, an event has occurred to request the data of type WeatherReport (i.e., WeatherReportRequested=1), the observation of the data of type WeatherReport has occurred (i.e., WeatherReportAvailable=1), and an associated text weather report (Good Weather or Bad Weather), is at hand.

A transition 58 can occur to cause the plan 50 to move from the state Sᵢ 52 to a state Sⱼ 60. The transition 58 is associated with a transition probability Pᵢⱼ^{GetWeatherReport}, which represents a probability that performing an action k (i.e., an action GetWeatherReport 68) results in the transition to the particular state Sⱼ 60. It should be apparent from discussion above that performing the action GetWeatherReport 68 can result in a transition to another state other than the state Sⱼ 60.

The events 54 can result in actions 68. In particular, the event WeatherReportRequested 54 can result in the action GetWeatherReport 68. In turn, since the nature of the observation of WeatherReport is not known in advance, the action GetWeatherReport can result in an observation 70 of the data of type WeatherReport equal to either A1 or A2, either one of which results in the state Sⱼ 60, wherein the observation WeatherReportAvailable becomes a one (i.e., true) and the data A1 or A2 is at hand.

The observation of the data corresponding to the WeatherReport is associated with observation probabilities Pᵢⱼ^{Bad Weather,GetWeatherReport} and Pᵢⱼ^{Good Weather,GetWeatherReport}. The observation probability Pᵢⱼ^{Bad Weather,GetWeatherReport} is the probability that the action GetWeatherReport will result in the observation of the data corresponding to the WeatherReport being equal to Bad Weather, represented by an arrow 74, which results in a transition 58 from the state Sᵢ 52 to the state Sⱼ 60, and which results in the state Sⱼ 60 including the observation WeatherReportAvailable=1 and the data of type WeatherReport=Bad Weather. Similarly, the observation probability Pᵢⱼ^{Good Weather,GetWeatherReport} is the probability that the action GetWeatherReport will result in the observation of the data corresponding to the WeatherReport being equal to Good Weather, represented by an arrow 72, which results in the transition 58 from the state Sᵢ 52 to the state Sⱼ 60, and which results in the state Sⱼ 60 instead including the observation WeatherReportAvailable=1 and the data of type WeatherReport=Good Weather.

It is also possible that the action GetWeatherReport 68 originating from the state Sᵢ 52 results in no data and the action GetWeatherReport 68 returns to the original state Sᵢ 52, which return is represented by an arrow 76.

It should be noted that this particular exemplary plan includes an observation state variable “Location.” The state variable Location has a value of Waypoint A in both state Sᵢ 52 and in state Sⱼ 70, i.e., the ship has not moved.

The above-described observation probabilities result in a so-called hidden Markov model associated with a plan. A hidden Markov model will be generally understood by those of ordinary skill in the art.

The systems and methods described herein apply in general to any defense or commercial plans, but are not limited to, construction plans, vehicle movement plans, equipment movement plans, and personnel movement plans. A vehicle movement plan can include a plan for moving a vehicle from a starting location to an ending location. An equipment movement plan can include a plan for moving equipment from a starting location to an ending location. A personnel movement plan can include a plan for moving at least one person from a starting location to an ending location. The personnel can be military or civilian personnel.

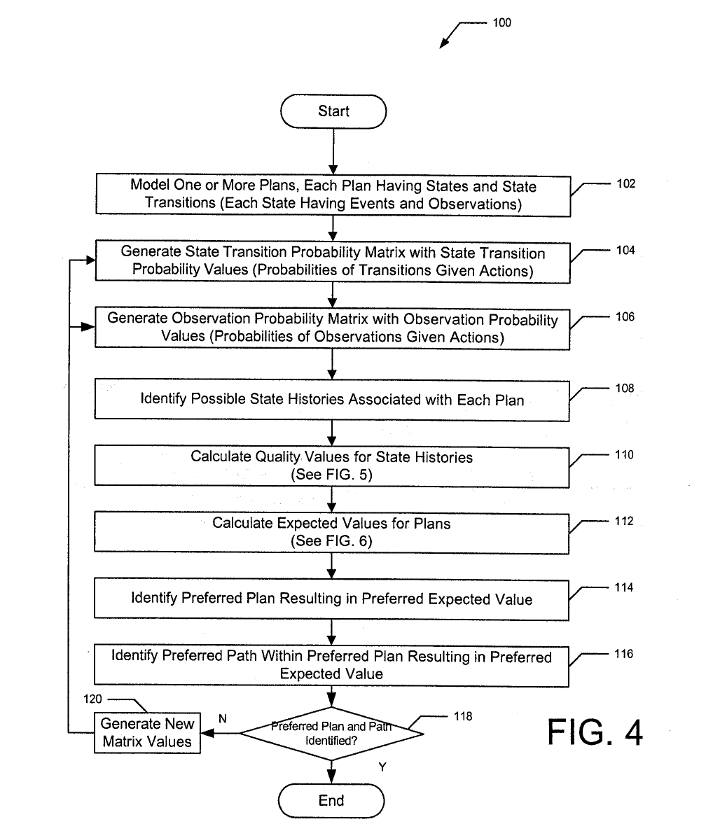

Referring now to FIGS. 3 and 3A, two plans 80, 90, respectively, can be compared by systems and methods described below in conjunction with FIGS. 4-7, in order to select a preferred one of the two 89, 90. Furthermore, in some embodiments, within the selected preferred plan, a preferred path between states can also be selected. It should, however, be recognized that any plurality of plans can be combined into one larger plan, or can be combined in any way to generate a smaller plurality of plans. When combined into one plan, or when only one plan originally exists, the systems and methods described below can be used to select a preferred path between states within the one plan.

Referring first to FIG. 3, the exemplary plan 80 can be associated, for example, with a ship traversing a plurality of waypoints. The plan 80 includes states S₁-S₈ coupled as shown by transitions represented by arrows. An initial state S₁ begins at a location waypoint A (WPA), which state has state variables equal to StateVariablesL. The state S₁ can transition to state S₂, S₅, or S₆, the transitions having transition probabilities P₁₂, P₁₅, or P₁₆, respectively. Other states and other state transition probabilities are shown. The plan 80 can terminate at any one of states S₄, S₇, or S₈, each of which is indicative of a location at a waypoint E (WPE).

One path shown as bold arrows from state S₁ to state S₂ to state S₅ to state S₇, is indicative of but one path, i.e., one state history, traversing the plan. Other state histories also traverse the plan.

It will be recognized that the state transition probabilities can be arranged as a state transition probability matrix. From the discussion above in conjunction with FIGS. 1 and 2, it will be understood that the various transition can also be associated with respective observation probabilities (not shown) but which can be similarly arranged in an observation probability matrix.

Referring now to FIG. 3A, another plan 90, different from the plan 80 of FIG. 3, includes states S₁′-S₅′, where the prime (′) symbol represents that the states S₁′-S₅′ may or may not be the same states as the states S₁-S₅ of FIG. 3. Similarly, the plan 90 of FIG. 3A includes state variables StateVariablesL′ to StateVariablesP′, which may or may not be the same as variables StateVariablesL to StateVariablesP of FIG. 3.

The plan 90 of FIG. 3A is indicative of a ship movement plan among waypoints A, B, D and F, beginning at waypoint A (WPA) and ending at waypoint F (WPF). For illustrative purposes, the waypoints A,B, and D are the same as the same waypoints in FIG. 3. Note however, that the plan 80 of FIG. 3A ends at waypoint F, which is not in the plan 80 of FIG. 3.

Systems and methods described below can select a preferred plan from among the plans 80, 90 of FIGS. 3 and 3A, respectively. Furthermore, the systems and methods described below, once having selected a preferred plan, for example, the plan 80 of FIG. 3, can select a preferred state history within the preferred plan 80, for example, the state history indicated by bold arrows within the plan 80 of FIG. 3.

It should be understood that the two plans 80, 90 of FIGS. 3 and 3A need not result in the same ending destination and still they can be compared. In fact, the two plans 80, 90 need not have very much similarity at all. As a simple example, if the plan 80 of FIG. 3 were a plan to drive from Boston to New York City, and the plan 90 of FIG. 3A were a plan to stay near Boston, it is possible that either one of the plans could be a preferred plan. For example, even if it is desired to get from Boston to New York City, if a snowstorm is immanent, a preferred plan may be to stay near Boston, traveling only to a Boston suburb, and visiting a relative. As described more fully below, the various states within a plan may be associated with costs and rewards. Where the costs are too great and outweigh the rewards in the plan to go from Boston to New York City (e.g., the plan 80 of FIG. 3), the preferred plan may be to stay near Boston (e.g., the plan 90 of FIG. 3A).

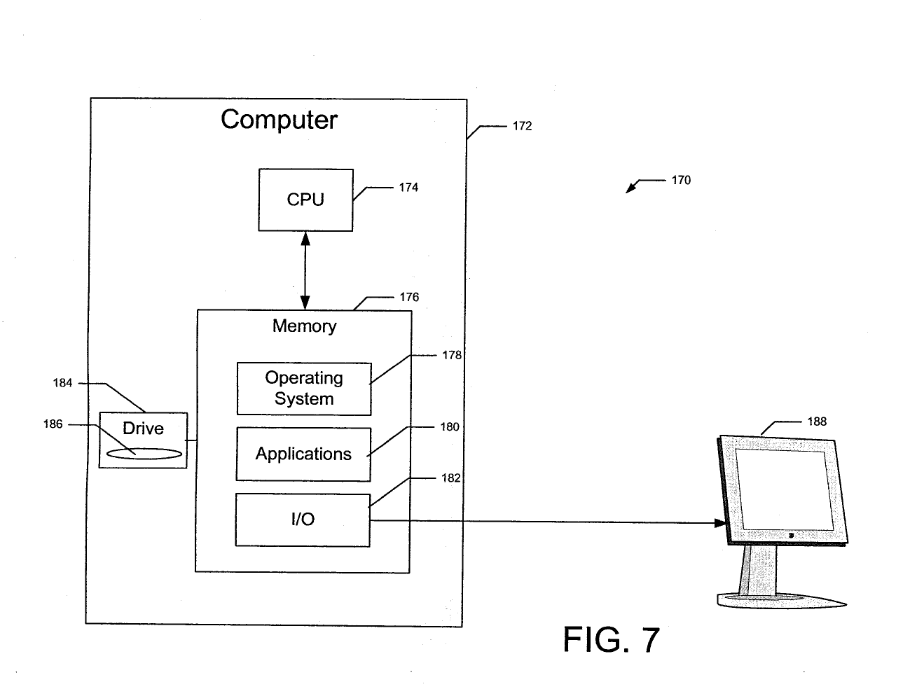

It should be appreciated that FIGS. 4-6 show flowcharts corresponding to the below contemplated techniques which would be implemented in computer system 170 (FIG. 7). Rectangular elements (typified by element 102 in FIG. 4), herein denoted “processing blocks,” represent computer software instructions or groups of instructions. Diamond shaped elements (typified by element 118 in FIG. 4), herein denoted “decision blocks,” represent computer software instructions, or groups of instructions, which affect the execution of the computer software instructions represented by the processing blocks.

Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied without departing from the spirit of the invention. Thus, unless otherwise stated the blocks described below are unordered meaning that, when possible, the steps can be performed in any convenient or desirable order.

Referring to FIG. 4, an exemplary method 100 begins at block 102, where one or more plans are modeled. Each one of the plans is modeled with a respective plurality of states as in FIGS. 3 or 3A, and with a respective plurality of transitions between the states.

For each one of the plans, at block 104, a respective state transition probability matrix is generated, which has respective state transition probability values (see, e.g., FIG. 1). The state transition probability matrix can be an initial state transition probability matrix having initial state transition probability values generated in a variety of ways. For example, in some arrangements, the initial state transition probability values are randomly generated. In other arrangements, the initial state transition probability values are manually selected based upon human knowledge. In still other arrangements, the initial state transition probability values are automatically selected based upon a knowledge database having knowledge of similar plans and similar state transitions.

At block 106, for each one of the plans, a respective observation probability matrix is generated, which has respective observation probability values (see, e.g., FIG. 1). The observation probability matrix can be an initial observation probability matrix having initial observation probability values generated in a variety of ways. For example, in some arrangements, the initial observation probability values are randomly generated. In other arrangements, the initial observation probability values are manually selected based upon prior knowledge (e.g., human knowledge). In still other arrangements, the initial observation probability values are automatically selected based upon a knowledge database having knowledge of similar plans and similar observations.

At block 108, possible state histories are identified for each one of the plans. One such state history is shown as bold arrows in FIG. 3.

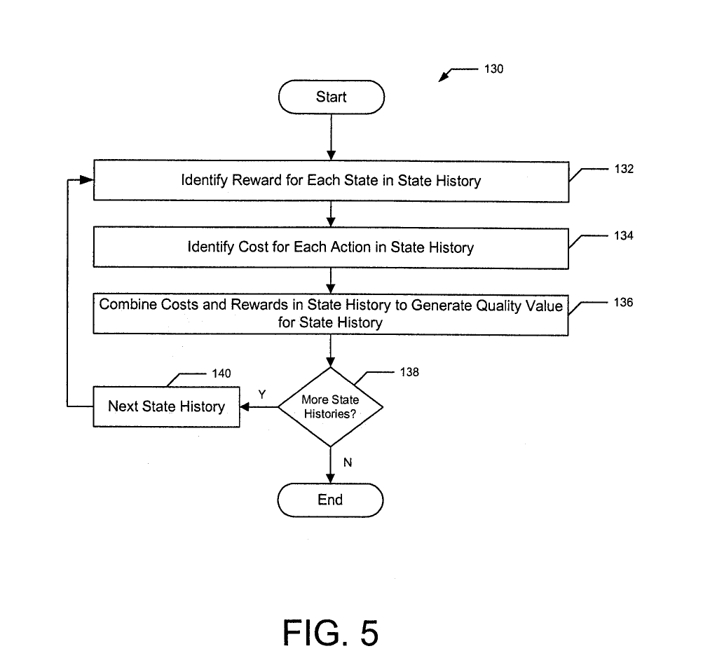

At block 110, a respective “quality value” is calculated for each of the state histories (or alternatively, for some of the state histories) identified at block 108. Calculation of quality values is described more fully below in conjunction with FIG. 5.

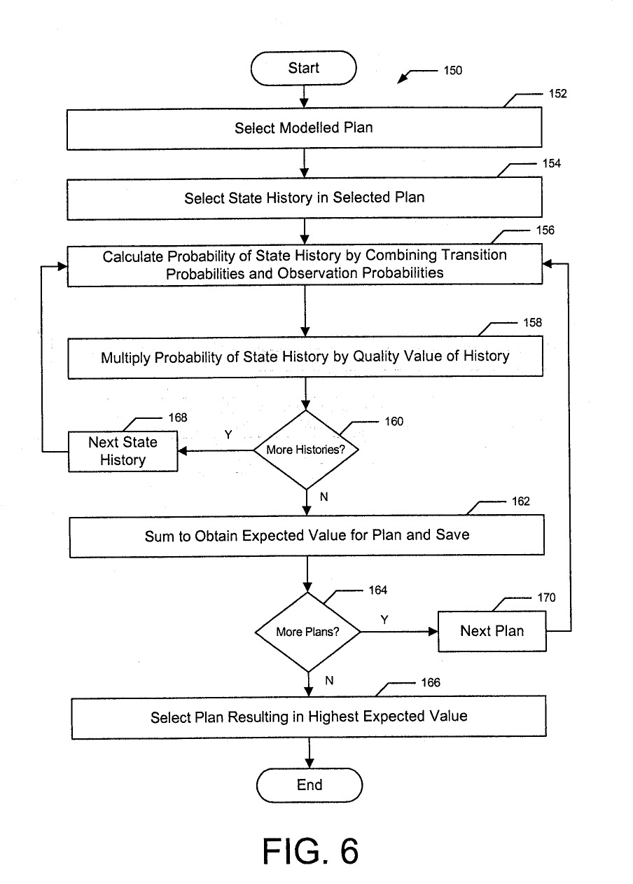

At block 112, using the quality values calculated at block 110, a respective “expected value” is calculated for each of the plans (or alternatively, for some of the plans) modeled at block 102. Calculation of expected values is described more fully below in conjunction with FIG. 6.

At block 114, a preferred plan is selected from among the plans modeled at block 102 (or alternatively, from among some of the plans). The preferred plan can be selected based upon a preferred expected value. For example, a preferred plan can be selected as the plan having the highest expected value. However, in other arrangements, a different preferred plan can be selected, but still according to the expected values of the various plans.

At block 116, within the preferred plan selected at block 114, a preferred path (state history) is selected. In some arrangements, the preferred state history is selected as the state history within the selected preferred plan, which has the highest quality value. However, in other arrangements, a different preferred state history can be selected, but still according to the quality values of the state histories within the preferred plan.

At block 118, if a preferred plan and/or a preferred path is not selected at blocks 114 and 118, as may be the case upon a first pass through the process 100 where only initial matrix values are used at blocks 104 and 108, then at block 120 new state transition probability values and/or new observation probability values are selected and the process returns to block 104 or 108 with the new values.

The new values can be selected in a variety of ways. For example, one or more of the plans identified at block 102 may have progressed within the real world, or within a simulation of the plan. One or more of the plans may have progressed beyond an initial state, in which case there may be knowledge as to past state transitions probability values and/or past observation probability values, either of which may be indicative of probability values to be expected in the future. For example, using the example plan of FIG. 3, upon requesting a weather report, it may be found that no such weather report exists, in which case future requests would be less likely to result in weather reports. As another example, a requested weather report may be indicative of a hurricane ahead, in which case a future request for another weather report is more likely than before to be indicative of bad weather.

At block 118, if the preferred plan and preferred path are acceptable, the method 100 ends.

Referring now to FIG. 5, a process 130 is representative of the calculation of quality values for the state histories, which is described above at block 110 of FIG. 4. At block 132, for each state in a state history identified at block 108 of FIG. 4, a reward is identified. The reward can have a reward value, which can be on an arbitrary relative scale. The reward can also be no reward.

At block 134, for each state in a state history identified at block 108 of FIG. 4, a cost is identified. The cost can have a cost value, which can be on an arbitrary relative scale. The cost can also be no cost.

At block 136, the costs and the rewards for a state history are combined to provide the calculated quality value for the state history. In one particular arrangement, the costs and rewards are combined according to the following equation.

$$V ( h ) = {\sum }_{t - 0}^{T - 1} ( R ( {s}^{t} ) - C ( {s}^{t} , {a}^{t} ) ) + ( R ( {s}^{T} ) \qquad ( eq . 1 )$$

where: V(h)=quality value of state history h
R(s^{t})=reward for state s^{t}
C (s^{t,} a^{t})=cost for action a^{t} in state s^{t}

While an equation expressing one particular combination of costs and rewards is shown above, in other arrangements, the costs and rewards can be combined in a different way to calculate the quality value. In some arrangements, for example, the costs and or rewards are multiplied by scalar values before combining.

The process 130 proceeds to block 138, where, if there are more state histories for which to calculate quality values, the process selects another state history at block 140 and returns to block 132. At block 138, if all of the desired state histories have been used for calculation of respective quality values, the process 130 ends.

Referring now to FIG. 6, a process 150 is representative of the calculation of “expected values” for the plans, which is described above at block 112 of FIG. 4. Beginning at block 152, a plan is selected from among the one or more plans modeled at block 102 of FIG. 4, and at block 154, a state history is selected from within the selected plan.

At block 154, a “probability of state history” is calculated for the selected state history, by combining (e.g., multiplying) respective state transition probabilities and observation probabilities along the state history. In some arrangements, the probability of a state history can be calculated by the following equation.

$$P ( h / π ) = {\sum }_{s ∈ {s}_{h}} {P}_{ij}^{x , y} ( s ) {P}_{ij}^{k} ( s ) \qquad ( eq . 2 )$$

where: P(h/π)=probability of state history h in plan π
s=state in state history h
Sₕ=all states in state history h

While an equation expressing one particular combination of probabilities is shown above, in other arrangements, the state transition probabilities and observation probabilities can be combined in a different way to calculate the probability of state history. In some arrangements, for example, the state transition probabilities and observation probabilities are multiplied by scalar values before combining.

At block 156, the probability of state history associated with the selected state history is combined with the quality value for the state history, which is calculated at block 110 of FIG. 4 and in process 130 of FIG. 5. In one particular embodiment, the combination is represented by the following equation.

V(h)P(h|π) (eq. 3)

where: P(h/π)=probability of state history h in plan π
V(h)=quality value of state history h

While an equation expressing one particular combination of probability of state history with quality value is shown above, in other arrangements, the probability of state history and quality value can be combined in a different way.

At block 156, if another state history associated with the selected plan exists, the process proceeds to block 168, where another state history is selected within the selected plan, and the process returns to block 156, resulting in calculation of another probability of state history at block 156 and another multiplication at block 158.

At block 156, if there are no more state histories in the selected plan, the products generated at block 158 are summed as in the following expression, to obtain an expected value for the selected plan. The expected value is saved, to be compared with other expected values associated with other plans.

$$EV ( π ) = {\sum }_{h ∈ {H}_{s}} V ( h ) P ( h \text{\textbar} π ) \qquad ( eq . 4 )$$

where: EV(π)=expected value of plan π
P(h|π)=probability of state history h in plan π
Hₛ=all state histories in plan π
V(h)=quality value of state history h

At block 164, if there are more plans to be compared, the process proceeds to block 170, where a next plan is selected, and the process returns to block 156, eventually resulting in an expected value associated with the next selected plan and so on.

At block 164, if there are no more plans to compare, the expected values generated at block 162 are compared at block 166. A preferred plan having the highest expected value can be identified. However, in other arrangements, the expected values can be used in a different way to select a preferred plan.

Referring again briefly to FIG. 4, at block 116 a preferred path (state history) can be selected within the preferred plan selected at block 166 of FIG. 6 as the state history having the highest quality value computed at block 136 of FIG. 5.

Referring now to FIG. 7, a computer system 172 can include a computer 172 and a display device 188. The computer 172 can include a central processing unit (CPU) 174 coupled to a computer-readable memory 176, a form of computer-readable storage medium, which can, for example, be a semiconductor memory. The memory 176 can store instructions associated with an operating system 178, associated with applications programs 180, and associated with input and output programs 182, for example a video output program resulting in a video output to the display device 188.

The computer 172 can also include a drive device 184, which can have a computer-readable storage medium 186 therein, for example, a CD or a floppy disk. The computer-readable storage medium 176 and/or the computer-readable storage medium 186 can be encoded with computer-readable code, the computer-readable code comprising instructions for performing at least the above-described processes of FIGS. 4-6.

All references cited herein are hereby incorporated herein by reference in their entirety.

Having described preferred embodiments of the invention it will now become apparent to those of ordinary skill in the art that other embodiments incorporating these concepts may be used. Additionally, the software included as part of the invention may be embodied in a computer program product that includes a computer readable storage medium. For example, such a computer readable storage medium can include a readable memory device, such as a hard drive device, a CD-ROM, a DVD-ROM, or a computer diskette, having computer readable program code segments stored thereon. A computer readable transmission medium can include a communications link, either optical, wired, or wireless, having program code segments carried thereon as digital or analog signals. Accordingly, it is submitted that the invention should not be limited to the described embodiments but rather should be limited only by the spirit and scope of the appended claims. All publications and references cited herein are expressly incorporated herein by reference in their entirety.

What is claimed is:

1. A computer-implemented method of identifying a preferred plan, comprising:
modeling one or more plans, each plan having a respective plurality of states and a respective plurality of transitions between the states;
generating a respective state transition probability matrix associated with each one of the one or more plans, each respective state transition probability matrix having respective state transition probability matrix values, each state transition probability matrix value corresponding to a respective probability that performing a respective action will result in a respective state transition;
generating a respective observation probability matrix associated with each one of the one or more plans, each respective observation probability matrix having respective observation probability matrix values, each observation probability matrix value corresponding to a respective probability of obtaining a respective observation in response to a respective action;
identifying a respective plurality of state histories associated with each one of the one or more plans, each state history having a respective plurality of states;
computing a respective quality value for each state history of the plurality of state histories;
computing a respective expected value for each plan of the one or more plans; and
identifying at least one of a preferred plan from among the one or more plans in accordance with the expected values of each plan of the one or more plans, or a preferred state history from among the respective plurality of state histories within the identified preferred plan, wherein the preferred state history is identified in accordance with the quality values.

2. The computer-implemented method of claim 1, wherein the generating a respective quality value for each state history of the plurality of state histories comprises:
identifying a respective reward value associated with each state for a respective one state history of the plurality of state histories;
identifying a respective cost value associated with each action, each action associated with a respective state for the respective one state history of the plurality of state histories; and
combining respective cost values and respective reward values for the respective one state history of the plurality of state histories to generate a respective quality value for the respective one state history of the plurality of state histories.

3. The computer-implemented method of claim 2, wherein the combining respective cost values and respective reward values comprises:
subtracting a cost value from a reward value to generate a state difference value for each state in the respective one state history of the plurality of state histories; and
summing the state difference values for each state in the respective one state history of the plurality of state histories.

4. The computer-implemented method of claim 1, wherein the generating a respective expected value for each plan of the one or more plans comprises combining respective quality values, respective state transition probability values, and respective observation probability values for each state history of the plurality of state histories associated with a respective one of the one or more plans.

5. The computer-implemented method of claim 4, wherein the combining respective quality values, respective state transition probability values, and respective observation probability values comprises:
calculating a respective probability of state history for each state history of the plurality of state histories associated with the respective one of the one or more plans;
multiplying each respective probability of state history by a respective quality value for each state history of the plurality of state histories associated with the respective one of the one or more plans to provide a respective state history product value for each state history of the plurality of state histories associated with the respective one of the one or more plans; and
summing the respective state history product values for each state history of the plurality of state histories associated with the respective one of the one or more plans.

6. The computer-implemented method of claim 5, wherein the generating a respective probability of state history comprises:
multiplying a state transition probability value associated with a selected state within a selected state history from among the plurality of state histories associated with the respective one of the one or more plans by an observation probability associated with a selected action associated with the selected state and with the selected state history from among the plurality of state histories associated with the respective one of the one or more plans to provide a probability product value; and.
summing the probability product values for each state and each action associated with the selected state history.

7. The computer-implemented method of claim 1, further comprising:
updating at least one of the state transition probability values or at least one of the observation probability values.

8. The computer-implemented method of claim 7, wherein the updated state transition probability values or the updated observation probability value are generated using a respective past state transition probability value or a respective past observation probability value.

9. The computer-implemented method of claim 1, wherein the one or more plans correspond to real-world plans.

10. The computer-implemented method of claim 9, wherein the real-world plans comprise at least one of a construction plan, a vehicle movement plan, an equipment movement plan, or a personnel movement plan.

11. The computer-implemented method of claim 10, wherein the vehicle movement plan comprises a plan for moving a vehicle from a starting location to an ending location resulting in movement of at least one person within the vehicle from the starting location to the ending location, wherein the vehicle comprises a selected one of a ship, an automobile, a truck, or an airplane.

12. The computer-implemented method of claim 10, wherein the equipment movement plan comprises a plan for moving equipment from a starting location to an ending location.

13. The computer-implemented method of claim 10, wherein the personnel movement plan comprises a plan for moving at least one person from a starting location to an ending location.

14. A computer-readable storage medium encoded with computer-readable code, comprising instructions for:
modeling one or more plans, each plan having a respective plurality of states and a respective plurality of transitions between the states;
generating a respective state transition probability matrix associated with each one of the one or more plans, each respective state transition probability matrix having respective state transition probability matrix values, each state transition probability matrix value corresponding to a respective probability that performing a respective action will result in a respective state transition;
generating a respective observation probability matrix associated with each one of the one or more plans, each respective observation probability matrix having respective observation probability matrix values, each observation probability matrix value corresponding to a respective probability of obtaining a respective observation in response to a respective action;
identifying a respective plurality of state histories associated with each one of the one or more plans, each state history having a respective plurality of states;
computing a respective quality value for each state history of the plurality of state histories;
computing a respective expected value for each plan of the one or more plans; and
identifying at least one more of a preferred plan from among the one or more plans in accordance with the expected values of each plan of the one or more plans, or a preferred state history from among the respective plurality of state histories within the identified preferred plan, wherein the preferred state history is identified in accordance with the quality values.

15. The computer-readable storage medium of claim 14, wherein the instructions for generating a respective quality value for each state history of the plurality of state histories comprise instructions for:
identifying a respective reward value associated with each state for a respective one state history of the plurality of state histories;
identifying a respective cost value associated with each action, each action associated with a respective state for the respective one state history of the plurality of state histories; and
combining respective cost values and respective reward values for the respective one state history of the plurality of state histories to generate a respective quality value for the respective one state history of the plurality of state histories.

16. The computer-readable storage medium of claim 15, wherein the instructions for combining respective cost values and respective reward values comprise instructions for:
subtracting a cost value from a reward value to generate a state difference value for each state in the respective one state history of the plurality of state histories; and
summing the state difference values for each state in the respective one state history of the plurality of state histories.

17. The computer-readable storage medium of claim 14, wherein the instructions for generating a respective expected value for each plan of the one or more plans comprise instructions for combining respective quality values, respective state transition probability values, and respective observation probability values for each state history of the plurality of state histories associated with a respective one of the one or more plans.

18. The computer-readable storage medium of claim 17, wherein the instructions for combining respective quality values, respective state transition probability values, and respective observation probability values comprise instructions for:
computing a respective probability of state history for each state history of the plurality of state histories associated with the respective one of the one or more plans;
multiplying each respective probability of state history by a respective quality value for each state history of the plurality of state histories associated with the respective one of the one or more plans to provide a respective state history product value for each state history of the plurality of state histories associated with the respective one of the one or more plans; and
summing the respective state history product values for each state history of the plurality of state histories associated with the respective one of the one or more plans.

19. The computer-readable storage medium of claim 18, wherein the instructions for generating a respective probability of state history comprise instructions for:
multiplying a state transition probability value associated with a selected state within a selected state history from among the plurality of state histories associated with the respective one of the one or more plans by an observation probability associated with a selected action associated with the selected state and with the selected state history from among the plurality of state histories associated with the respective one of the one or more plans to provide a probability product value; and.
summing the probability product values for each state and each action associated with the selected state history.

20. The computer-readable storage medium of claim 14, further comprising instructions for:
updating at least one of the state transition probability values or at least one of the observation probability values.

21. The computer-readable storage medium of claim 20, wherein the updated state transition probability values or the updated observation probability value are generated using a respective past state transition probability value or a respective past observation probability value.

22. The computer-readable storage medium of claim 14, wherein the one or more plans correspond to real-world plans, wherein the real-world plans comprise at least one of a construction plan, a vehicle movement plan, an equipment movement plan, or a personnel movement plan.

23. A system, comprising:
a computer processor; and
a computer-readable memory coupled to the computer processor, wherein the computer-readable memory is encoded with computer-readable code, the computer-readable code comprising instructions for:
modeling one or more plans, each plan having a respective plurality of states and a respective plurality of transitions between the states;
generating a respective state transition probability matrix associated with each one of the one or more plans, each respective state transition probability matrix having respective state transition probability matrix values, each state transition probability matrix value corresponding to a respective probability that performing a respective action will result in a respective state transition;
generating a respective observation probability matrix associated with each one of the one or more plans, each respective observation probability matrix having respective observation probability matrix values, each observation probability matrix value corresponding to a respective probability of obtaining a respective observation in response to a respective action;
identifying a respective plurality of state histories associated with each one of the one or more plans, each state history having a respective plurality of states;
computing a respective quality value for each state history of the plurality of state histories;
computing a respective expected value for each plan of the one or more plans; and
identifying at least one of a preferred plan from among the one or more plans in accordance with the expected values of each plan of the one or more plans, or a preferred state history from among the respective plurality of state histories within the identified preferred plan, wherein the preferred state history is identified in accordance with the quality values.

24. The system of claim 23, wherein the instructions for generating a respective quality value for each state history of the plurality of state histories comprise instructions for:
identifying a respective reward value associated with each state for a respective one state history of the plurality of state histories;
identifying a respective cost value associated with each action, each action associated with a respective state for the respective one state history of the plurality of state histories; and
combining respective cost values and respective reward values for the respective one state history of the plurality of state histories to generate a respective quality value for the respective one state history of the plurality of state histories.

25. The system of claim 24, wherein the instructions for combining respective cost values and respective reward values comprise instructions for:
subtracting a cost value from a reward value to generate a state difference value for each state in the respective one state history of the plurality of state histories; and
summing the state difference values for each state in the respective one state history of the plurality of state histories.

26. The system of claim 23, wherein the instructions for generating a respective expected value for each plan of the one or more plans comprise instructions for combining respective quality values, respective state transition probability values, and respective observation probability values for each state history of the plurality of state histories associated with a respective one of the one or more plans.

27. The system of claim 26, wherein the instructions for combining respective quality values, respective state transition probability values, and respective observation probability values comprise instructions for:
computing a respective probability of state history for each state history of the plurality of state histories associated with the respective one of the one or more plans;
multiplying each respective probability of state history by a respective quality value for each state history of the plurality of state histories associated with the respective one of the one or more plans to provide a respective state history product value for each state history of the plurality of state histories associated with the respective one of the one or more plans; and
summing the respective state history product values for each state history of the plurality of state histories associated with the respective one of the one or more plans.

28. The system of claim 27, wherein the instructions for generating a respective probability of state history comprise instructions for:
multiplying a state transition probability value associated with a selected state within a selected state history from among the plurality of state histories associated with the respective one of the one or more plans by an observation probability associated with a selected action associated with the selected state and with the selected state history from among the plurality of state histories associated with the respective one of the one or more plans to provide a probability product value; and.
summing the probability product values for each state and each action associated with the selected state history.

29. The system of claim 23, wherein the computer-readable code further comprises instructions for:
updating at least one of the state transition probability values or at least one of the observation probability values.

30. The system of claim 29, wherein the updated state transition probability values or the updated observation probability value are generated using a respective past state transition probability value or a respective past observation probability value.

31. The system of claim 23, wherein the one or more plans correspond to real-world plans, wherein the real-world plans comprise at least one of a construction plan, a vehicle movement plan, an equipment movement plan, or a personnel movement plan.
